(19) United States
(12) Patent Application Publication
(10) Pub. No.: US 2008/0005265 A1
(43) Pub. Date: Jan. 3, 2008

(54) METHOD FOR AUTOMATIC PARSING OF VARIABLE DATA FIELDS FROM TEXTUAL REPORT DATA

(75) Inventors: Markus Miettinen, Helsinki (FI); Kimmo Hatonen, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/427,926

(22) Filed: Jun. 30, 2006

(51) Int. Cl. G06F 15/16

(52) U.S. Cl. 709/217

(57) ABSTRACT

A method and system for parsing textual report data found in free-text fields is disclosed. The textual report data may be included in log files that document a systems operation. A message template is created from reports or log data and used to automate the parsing of these variable data fields.

### FIELD OF THE INVENTION

Aspects of the invention relate generally to a method and system for processing textual report data. More particularly, an aspect of the invention relates to parsing log or report data by creating message templates to be used by a parser for use in parsing free-text message fields.

### BACKGROUND

In many computer systems, information about the computer systems operation is documented in log files or reports that contain textual data. Log files typically contain log data that describe the behavior of a system and/or components thereof and relevant events that occur within the system. Log files may be an important source of information for monitoring and/or analyzing a computer system as log files may assist in understanding what has happened and/or is happening in the computer system.

Typically log files and/or log reports contain records that include text strings. The records often include specific data fields like date, time, process id, username, hostname, etc . . . . These data fields often have a clear semantic meaning and follow a syntax that makes it possible to parse these fields from the text string. For example, the fields are often separated by specific field separator characters like semicolon, tabulator, comma, or other field separator. The data fields in the numerous records are easy to parse and may be processed automatically in a computer system given that one has knowledge of the syntax of the log or report type.

However, many log files and log reports also contain data fields that have a free-text structure, i.e., they consist of a character string that makes sense to a reader of the log file, but do not follow any specified strict syntax. Parsing such data fields automatically in a computer system is very difficult and inefficient.

For example, a free-text message such as “The process XZFG has started. [PID 7998]” may be located in a log file. The free-text message may consist of a message template such as:

“The process ______ has started. [PID ______]”

The above message template may also include the variable values “XZFG” and “7998”. For a reader of the log report, the distinction may be easy to make, but the automatic parsing of the message would require that a predefined regular expression for the message template exists. Without it, automatic parsing of the parameter values would be very difficult as there is no obvious syntax defining, which words of a free-text message are to be treated as variables and which words belong to the message template.

Free-text fields are often generated by computer programs that take a message template (e.g. “Process variablea exited. (Error code: variableb)”) containing variables and substitutes the variables with specific values (e.g. “ABCDZ” and “−1”) that make sense for the specific instantiation of the message. The resulting message string is inserted as a single data field into the data record in question (e.g. “Process ABCDZ exited. (Error code: −1)”). Often the message template is designed by the programmer so that the resulting message string represents a phrase or an expression in a human language like English, Finnish, or German. In legacy applications, the merging of the message template and the variable values is done in a way that the syntactic information about the special meaning of the variable values within the message string is often lost. From a syntactic point of view, text tokens representing variable values become indistinguishable from text tokens that are part of the message template. It is therefore very difficult to construct parsers that would be able to extract the variable values from within the message string. This is especially hard for legacy or third party applications, as often there are no exact specifications or documentation of the various message templates available when a parser is created.

Previously, the only way to tackle this problem was to manually construct parsers that would know how to handle different kinds of messages. The programmer of the parser would have to manually inspect the messages and construct regular expressions that describe the structure of the message template as accurately as possible. However, the programmer normally does not have access to the specifications or documentation about all the possible message templates available. The actual construction of the regular expressions for parsing the messages is therefore a trial-and-error procedure in which the programmer first constructs regular expressions and then tests them on real message data in order to find out if the regular expressions correctly cover all messages appearing in the test data. This procedure is tedious and error-prone and may only be performed manually.

In addition to the manual construction of parsers, pattern mining has also been frequently used and is known in the field. For instance, frequent pattern mining algorithms are known, such as the Apriori algorithm (See; Agrawal, R., Mannila, H., Srikant, R., Toivonen, H. and Verkamo, A. I. 1996. Fast Discovery of Association Rules. In Fayyad, U. M., Piatetsky-Shapiro, G., Smyth, P. and Uthurusamy, R., eds., Advances in Knowledge Discovery and Data Mining. AAAI/MIT Press. Chapter 12, 307-328).

A frequent pattern refers to a pattern whose frequency is greater than or at least as great as a frequency threshold. Frequent patterns may be either frequent sets or frequent episodes. Moreover, a frequent pattern may be formed by one or more frequent sets or frequent episodes that are present in the data. A set commonly refers to a set of attribute values or binary attributes. A transaction may be a set of one or more database tuples or rows. An episode is a sequence (ordered or unordered) of events or data items that are present in the data. Additional information regarding frequent episodes may be found in Heikki Mannila, Hannu Toivonen, and A. Inkeri Verkamo, Discovery of frequent episodes in event sequences. Data Mining and Knowledge Discovery, 1(3):259-289, 1997. A transaction may often manifest itself as an episode in the data.

Closed sets are derivatives of frequent sets and may be used in mining algorithms. An example of a closed set mining algorithm is presented by Jean-Francois Boulicaut and Artur Bykowski in an article entitled “Frequent closures as a concise representation for binary data mining” published in the Proceedings PAKDD'00, volume 1805 of LNAI, pages 62-73, Kyoto, J P, on April 2000, Springer-Verlag.

Free sets may also be used in mining algorithms. An example of free set mining algorithms is presented by Jean-Francois Boulicaut, Artur Bykowski, and Christophe Rigotti in an article entitled “Approximation of frequency queries by mean of free-sets” published in Proceedings PKDD'00, volume 1910 of LNAI, pages 75-85, Lyon, F, on September 2000, Springer-Verlag.

Therefore, there is a need in the art for a method and system for parsing free-text data fields in log reports that overcomes the shortcoming of prior approaches.

### SUMMARY

Aspects of the invention overcome problems and limitations of the prior art by providing a method of and system for processing textual report data. In an aspect of the invention, a method and system is described for parsing free-text data fields found in reports or log data. A message template may be created from reports or log data and may be used by a parser.

In an aspect of the invention, a data mining algorithm may be used to find frequent patterns (e.g. closed patterns or free patterns) that may be used to identify the message templates that are present in a specific set of log or report data. In an embodiment, free-text messages are split into textual tokens, i.e., words. The sequences of text tokens may then be used as input to a frequent pattern mining algorithm, which mines the data for combinations of tokens that frequently occur together in the same message or transaction. Frequent patterns may be input into a post-processing procedure, which performs post-selection of suitable patterns to be used as message templates for the parser.

In various aspects of the invention, the invention may be partially or wholly implemented with a computer-readable medium, for example, by storing computer-executable instructions or modules, or by utilizing computer-readable data structures. Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 illustrates a diagram of a computer system or network that may be used to implement aspects of the invention.

FIG. 2 illustrates a functional block diagram of a conventional general-purpose computer system that can be used to implement various aspects of the invention.

FIG. 3A illustrates a method of parsing free-text data fields in accordance with an aspect of the invention.

FIG. 3B illustrates another method of parsing free-text data fields in accordance with an aspect of the invention.

FIG. 4 illustrates exemplary input and output data which may be used for parsing of free-text data in accordance with an aspect of the invention.

FIG. 5 illustrates the method of parsing data applied recursively to log entry chains in order to detect variable log entries in entry chains in accordance with an aspect of the invention.

### DETAILED DESCRIPTION

### Exemplary Operating Environment

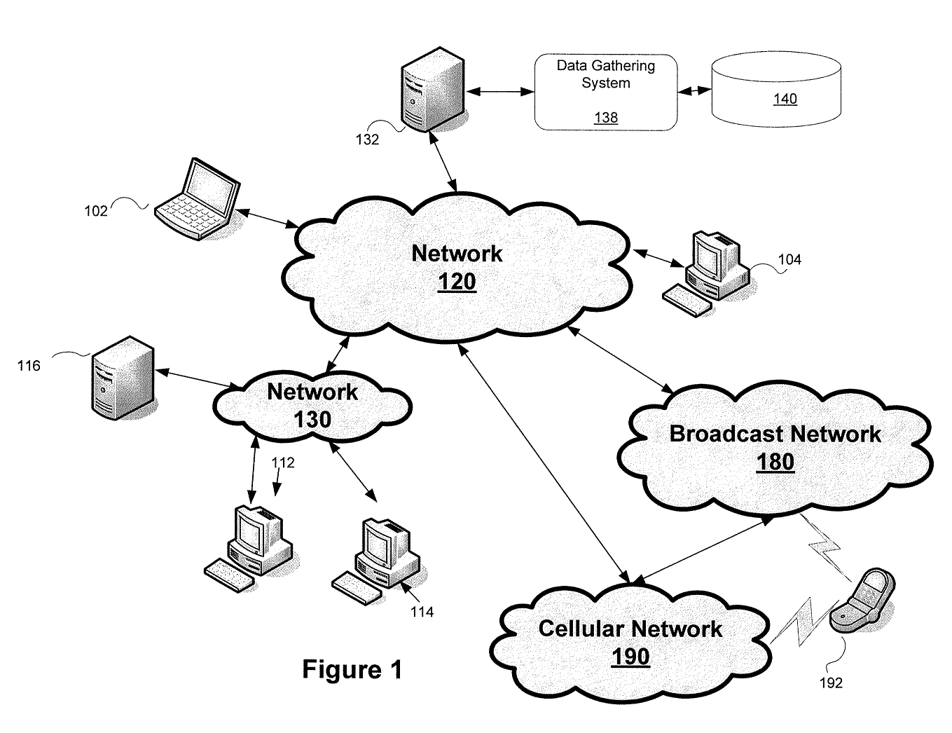

FIG. 1 shows a diagram of a system including a telecommunication system coupled to a computer system that may be used to implement aspects of the invention. The illustrated systems may communicate information between each other via various networks such a network 120, 130, 180, and 190. The term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” but also a “content network,” which is comprised of the data-attributable to a single entity-which resides across all physical networks.

A plurality of computers, such as computers 102 and 104, may be coupled to user computers 112, 114 and 116 via networks 120 and 130. User computers 112, 114, and 116 may also be coupled to report parsing computer 132. One or more of the computers shown in FIG. 1 may include a variety of interface units and drives for reading and writing data or files. One skilled in the art will appreciate that networks 120, 130, 180, and 190 are for illustration purposes and may be replaced with fewer or additional computer networks.

One or more networks may be in the form of a local area network (LAN) that has one or more of the well-known LAN topologies and may use a variety of different protocols, such as Ethernet. One or more of the networks may be in the form of a wide area network (WAN), such as the Internet.

The cellular network 190 may comprise a wireless network and a base transceiver station transmitter (not shown). The cellular network may include a second/third-generation (2G/3G) cellular data communications network, a Global System for Mobile communications network (GSM), GPRS, Wi-Fi, UMTS, CDMA, WCDMA, or other wireless communication network such as a WLAN network.

In addition, a broadcasting network 180 may include a radio transmission of IP datacast over DVB-H. The broadcast network 180 may broadcast a service such as a digital or analog television signal and supplemental content related to the service via a transmitter (not shown). The broadcast network 180 may also transmit supplemental content which may include a television signal, audio and/or video streams, data streams, video files, audio files, software files, and/or video games.

A mobile device such as mobile device 192 may comprise a wireless interface configured to send and/or receive digital wireless communications within cellular network 190 or broadcasting network 180. The mobile device may comprise a mobile telephone, personal digital assistants (PDAs), a digital player, a mobile terminal or the like. The information received by mobile device 192 through the cellular network 190 or broadcast network 180 may include voice data, electronic images, audio clips, and video clips. As part of cellular network 190, one or more base stations (not shown) may support digital communications with mobile device 192 while the mobile device 192 is located within the administrative domain of cellular network 190.

Computer devices such as computers 102, 104, and 112-116 may be connected to one or more of the networks via twisted pair wires, coaxial cable, fiber optics, radio waves or other media. It will also be appreciated that the network connections shown are illustrative and other techniques for establishing a communications link between the computers can be used such as TCP/IP, Bluetooth, Ethernet, FTP, HTTP, and IEEE 802.11x and the like may be utilized.

In an aspect of the invention, report parsing computer 132 may require information from external sources to process textual report data found in various log files and/or reports. Requests for such information may be transmitted from report parsing computer 132 to a data gathering system 138. Data gathering system 138 may include a processor, memory and other conventional computer components and may be programmed with computer-executable instructions to communicate with other computers and/or telecommunications devices. Data gathering system 138 may access such information from various data stores such as data store 140. Data store 140 may store log files and reports for a specified period of time for later review and analysis. In an embodiment of the invention, all report data may be stored in data store 140 and may be implemented with a group of networked server computers or other storage devices.

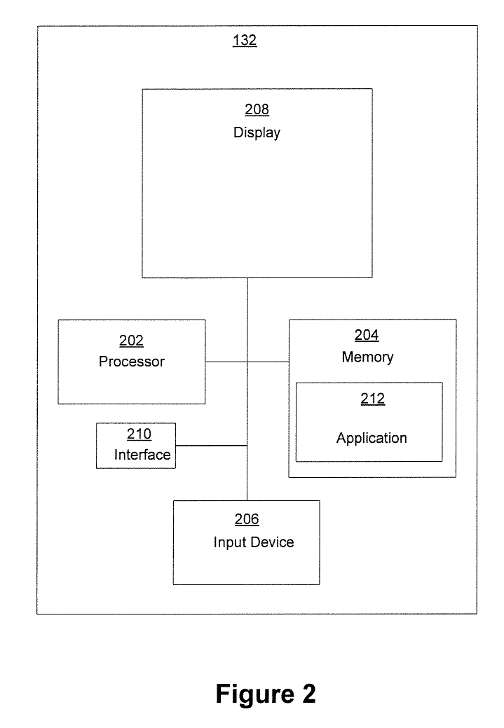

Report parsing computer 132 may be programmed with computer-executable instructions to parse log file data. With reference to FIG. 2, an exemplary form of report parsing computer 132 is illustrated. In an aspect of the invention, report parsing computer 132 may include a processing unit such as processor 202 and a memory 204. The memory 204 may be volatile (such as RAM), non-volatile (such as ROM, flash memory, etc.) or some combination of the two. The memory 204 may store applications 212 or computer-executable instructions to be executed on processor 202. Report parsing computer 132 may also include an input device 206 and a display 208. In addition, when used with a network as illustrated in FIG. 1, report parsing computer 132 may be connected to the network through a network interface or adapter 210. When used in a WAN networking environment, the report logging computer 132 may include a modem or other means for establishing communications over the wide area network, such as the Internet.

### Exemplary Embodiments

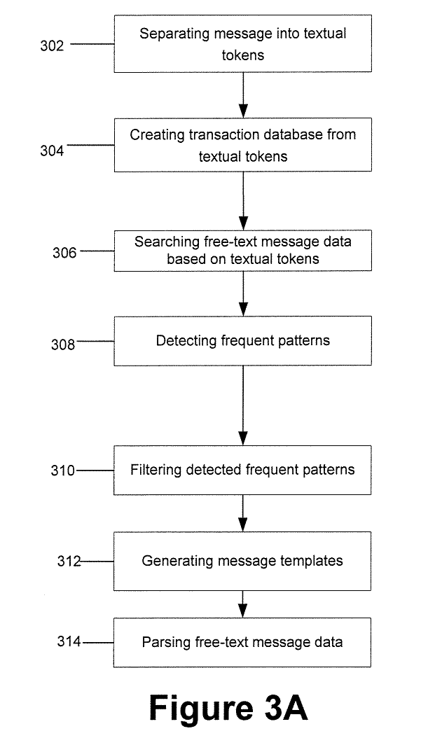

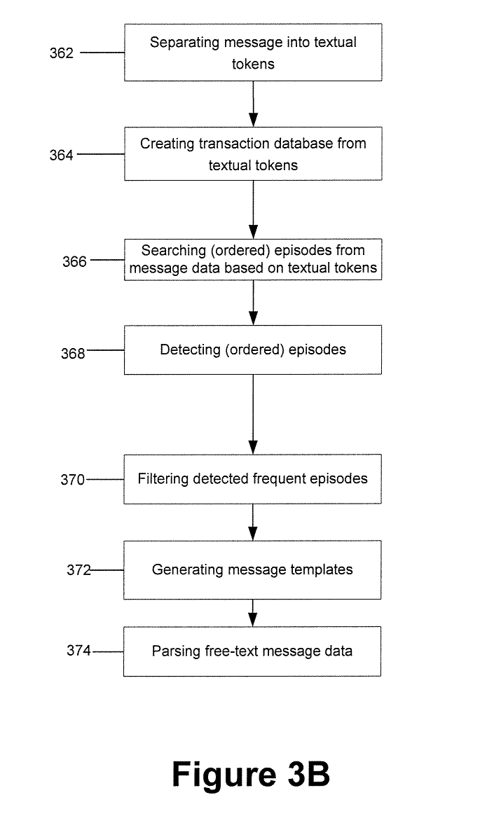

FIG. 3A illustrates a method of parsing free-text data fields in accordance with an aspect of the invention. In an aspect of the invention, a method for semi-automatic creation of message templates for use in parsing free-text fields by a data parser is used on various report or log files. The log files may be stored in compressed form to save storage space. Such compressed log files may have to be decompressed before searching for frequent patterns.

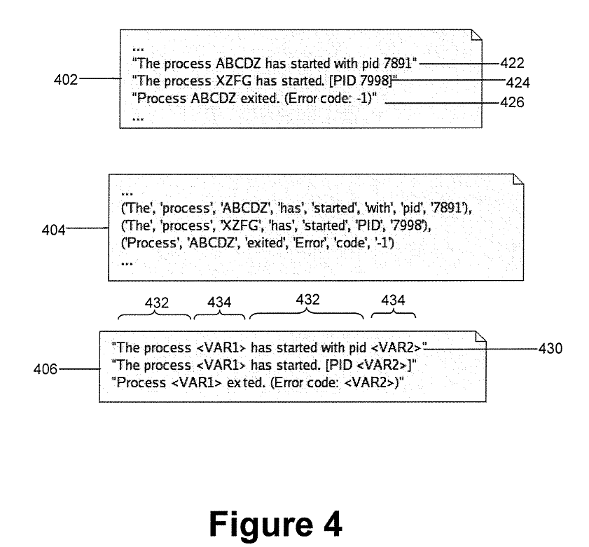

In FIG. 4, an excerpt 402 from a log file is illustrated. As shown in FIG. 4, the excerpt 402 comprises three rows of data 422-426. Data rows 422-426 are only illustrative as those skilled in the art will realize that log files may be comprised of numerous additional rows of data. Each of the rows of data 422-426 may comprise data fields some of which may be free-text fields.

Returning to FIG. 3A in step 302, the sampled message may be separated or split into textual tokens. Depending upon the log type non-word characters in the message string may be interpreted as word delimiters and may be omitted. The textual tokens or words may include a sequence of characters. For example, FIG. 4 illustrates exemplary output 404 after extraction of the textual tokens.

Next, in step 304 a transaction database may be created from the textual tokens. The transaction database may be located external to the computing device such as data store 140.

In step 306, a search may be conducted to detect frequent patterns as illustrated in step 308. As those skilled in the art will realize searching for frequent patterns may involve an iterative process that may require several iterations of scanning until detection of frequent pattern emerges.

In an aspect of the invention, a frequent pattern may refer to a pattern whose frequency is greater than or at least as great as a frequency threshold. In another aspect of the invention, a frequent pattern may refer to selection of most often occurring patterns that emerge during the searching process. In various other embodiments, frequent patterns may comprise frequent sets, free sets and/or closed sets. A frequent pattern mining algorithm like, e.g., the Apriori algorithm may be used to detect the frequent patterns. However, as those skilled in the art will realize other frequent pattern mining algorithms may be utilized that are able to find frequent patterns in the data. The frequent patterns may be combinations of items (i.e., words) that occur often (i.e., there are more occurrences than a specified frequency threshold) together in the same transaction. In another aspect of the invention, a frequency detection algorithm may be used to detect frequent patterns.

In step 310, the detected frequent patterns may be filtered to detect various arrangements of patterns. The filtering of the frequent patterns may include examining each detected frequent pattern for various arrangements of patterns. The filtering may be used so that only patterns that represent message templates remain. Each item of a frequent pattern may be analyzed with the position of each item in the detected frequent pattern determined. As used in various aspects of the invention, position may refer to absolute positions of items within a record and/or relative positions between items. Those skilled in the art will realize that a position may be a distance measured from beginning or end of text. Furthermore, relative distances may be measured from message end, from middle most token, from an arbitrary anchor point, and/or related to other tokens included in a frequent pattern.

The position of each item of the detected frequent pattern may be compared. If the pattern consists of items whose positions within the transactions from which they originate are consecutive and there are gaps of at most “n” positions between the items, then the pattern is interpreted to represent a message template. The variable n may represent the maximum number of words that a variable field may contain. The variable n may be adjusted, but reasonable results may be obtained with values of n=1, n=2, n=3, and n=4. Those skilled in the art will realize that various other values may also be freely selected for n. The gaps in the pattern may represent variables that have been inserted into the template.

The results of filtering in step 310 may be displayed on display 208. For example, FIG. 4 illustrates results of filtering in step 310 at 406. As may be seen at 406, the patterns that represent message templates have been distinguished from the variable values. For instance in data row 430, the patterns that represent the template are indicated at 432; whereas, the variable values are indicated at 434. The displaying of the results of filtering step 310 may allow for additional review of patterns that may have accidentally been identified by the method as message templates.

In step 312, a message template may be generated based on the arrangements of patterns. The generated message templates may be used to parse free-text message data on an automatic basis as shown in step 314. The parsing of free-text message data based on a generated template may allow for processing of legacy log reports for various systems that include audit, financial reporting, and/or other similar systems.

In another aspect of the invention, frequent episodes may also be detected. In FIG. 3B in a step 362, the sampled message may be separated or split into textual tokens. Depending upon the log type non-word characters in the message string may be interpreted as word delimiters and may be omitted. The textual tokens or words may include a sequence of characters. Next, in step 364 a transaction database may be created from the textual tokens. The transaction database may be located external to the computing device such as data store 140.

In step 366, a search may be conducted to detect frequent episodes as illustrated in step 368. As those skilled in the art will realize searching for frequent episodes may involve an iterative process that may require several iterations of scanning until detection of frequent pattern emerges.

In step 370, the detected frequent episodes may be filtered to detect various arrangements of patterns. Each item of a frequent episode may be analyzed with the position of each item in the detected frequent episode determined. As used in various aspects of the invention, position may refer to absolute positions of items within a record and/or relative positions between items. Those skilled in the art will realize that a position may be a distance measured from beginning or end of text. Furthermore, relative distances may be measured from message end, from middle most token, from an arbitrary anchor point, and/or related to other tokens included in a frequent episode.

The position of each item of the detected frequent episode may be compared. The results of filtering in step 360 may be displayed on display 208. In step 372, a message template may be generated based on the arrangements of episodes. The generated message templates may be used to parse free-text message data on an automatic basis as shown in step 374.

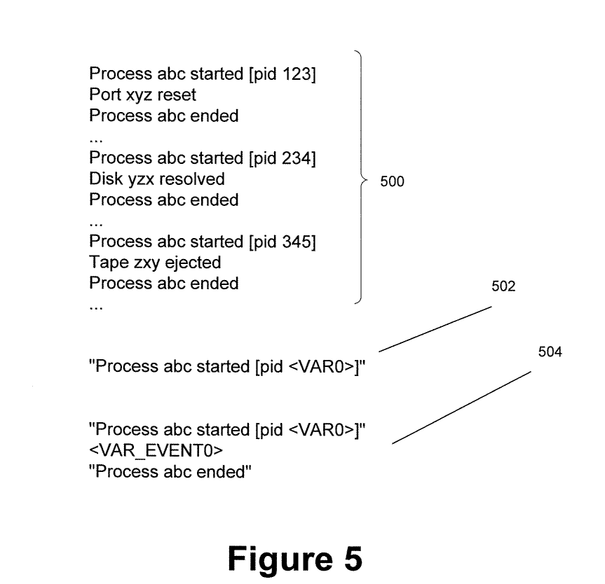

In another aspect of the invention, the methods described above may be applied recursively to log entry chains in order to detect variable log entries in entry chains as illustrated in FIG. 5 with example 500. As shown, the first iteration may produce the template as illustrated at 502. In a second iteration on “event tokens,” the template may be updated as shown at 504 of FIG. 5 to include the event variable.

While the invention has been described with respect to specific examples including presently preferred modes of carrying out the invention, those skilled in the art will appreciate that there are numerous variations and permutations of the above described systems and techniques that fall within the spirit and scope of the invention.

What is claimed:

1. A method of parsing free-text data fields, the method comprising:
(a) detecting free-text message data located in the free-text data fields;
(b) separating the detected free-text message data into textual tokens;
(c) searching the free-text message data based on the textual tokens;
(d) detecting frequent patterns within the free-text message data;
(e) filtering the detected frequent patterns for arrangements of patterns;
(i) generating the message templates based on the arrangements of patterns; and
(g) parsing free-text message data based on the generated message templates.

2. The method of claim 1, wherein filtering the detected frequent patterns for arrangements in (e) further includes examining each detected frequent pattern, the examination including:
(i) analyzing each item of a detected frequent pattern;
(ii) determining the position of each item in the detected frequent pattern;
(iii) comparing the position of each item in the detected frequent pattern; and
(iv) determining if the items within the detected frequent pattern are consecutive and whether there are gaps of at most n positions between the items.

3. The method of claim 1, wherein the frequent patterns comprise closed sets.

4. The method of claim 1, wherein the frequent patterns comprise free sets.

5. The method of claim 1, wherein the frequent patterns comprise closed episodes.

6. The method of claim 1, wherein the frequent patterns comprise frequent episodes.

7. The method of claim 1, further comprising (h) displaying the detected frequent patterns.

8. The method of claim 1, wherein the textual tokens include words and punctuation.

9. The method of claim 8, wherein the words include a sequence of characters.

10. The method of claim 9, wherein the sequence of characters are contiguous.

11. The method of claim 1, wherein the detecting of frequent patterns in (d) comprises executing a data mining algorithm.

12. The method of claim 11, wherein the data mining algorithm comprises a frequent set mining algorithm.

13. The method of claim 11, wherein the data mining algorithm comprise a frequent episode mining algorithm.

14. A method of generating a message template for parsing free-text data fields, the method comprising:
(a) detecting free-text message data;
(b) detecting frequent patterns within the free-text message data;
(c) filtering the detected frequent patterns for arrangements of patterns; and
(d) creating the message template based on the arrangements of patterns.

15. The method of claim 14, wherein filtering the detected frequent patterns for arrangements in (c) further includes examining each detected frequent pattern, the examination including:
(i) analyzing each item of a detected frequent pattern;
(ii) determining the position of each item in the detected frequent pattern;
(iii) comparing the position of each item in the detected frequent pattern; and
(iv) determining if the items within the detected frequent pattern are consecutive and whether there are gaps of at most n positions between the items.

16. The method of claim 14, wherein the frequent patterns comprise closed sets.

17. The method of claim 14, wherein the frequent patterns comprise free sets.

18. The method of claim 14, wherein the frequent patterns comprise frequent episodes.

19. The method of claim 14, wherein the frequent patterns comprise closed episodes.

20. The method of claim 14, further comprising (e) displaying the detected frequent patterns.

21. The method of claim 14, wherein the detecting of frequent patterns in (b) comprises executing a frequency detection algorithm.

22. The method of claim 14, wherein the detecting of frequent patterns in (b) comprises executing a data mining algorithm.

23. The method of claim 22, wherein the data mining algorithm comprises the Apriori algorithm.

24. The method of claim 22, wherein the data mining algorithm comprises a frequent set mining algorithm.

25. A system for parsing free-text data fields, the system comprising:
(a) a storage medium;
(b) at least one processor coupled to the storage medium and programmed with computer-executable instruction for performing:
(i) detecting free-text message data located in the free-text data fields;
(ii) separating the detected free-text message data into textual tokens;
(iii) searching the free-text message data based on the textual tokens;
(iv) detecting frequent patterns within the free-text message data;
(v) filtering the detected frequent patterns for arrangements of patterns;
(vi) generating the message templates based on the arrangements of patterns; and
(vii) parsing free-text message data based on the generated message templates.

26. The system of claim 25, wherein filtering the detected frequent patterns for arrangements in (v) further includes examining each detected frequent pattern, the examination including:
(I) analyzing each item of a detected frequent pattern;
(II) determining the position of each item in the detected frequent pattern;
(III) comparing the position of each item in the detected frequent pattern; and
(IV) determining if the items within the detected frequent pattern are consecutive and whether there are gaps of at most n positions between the items.

27. A computer-readable medium having computer-executable instructions for performing steps comprising:
(a) detecting free-text message data;
(b) detecting frequent patterns within the free-text message data;
(c) filtering the detected frequent patterns for arrangements of patterns; and
(d) creating the message template based on the arrangements of patterns.

28. The computer-readable medium of claim 27, wherein filtering the detected frequent patterns for arrangements in (c) further includes examining each detected frequent pattern, the examination including:
(i) analyzing each item of a detected frequent pattern;
(ii) determining the position of each item in the detected frequent pattern;
(iii) comparing the position of each item in the detected frequent pattern; and
(iv) determining if the items within the detected frequent pattern are consecutive and whether there are gaps of at most n positions between the items.

29. The computer-readable medium of claim 27, wherein the frequent patterns comprise closed sets.

30. The computer-readable medium of claim 27, wherein the frequent patterns comprise free sets.

31. The computer-readable medium of claim 27, wherein the frequent patterns comprise closed episodes.

32. The computer-readable medium of claim 27, wherein the frequent patterns comprise frequent episodes.

33. An apparatus comprising:
a communication interface;
a storage medium; and
a processor coupled to the storage medium and programmed with computer-executable instructions to perform the steps comprising:
(a) detecting free-text message data located in the free-text data fields;
(b) separating the detected free-text message data into textual tokens;
(c) searching the free-text message data based on the textual tokens;
(d) detecting frequent patterns within the free-text message data;
(e) filtering the detected frequent patterns for arrangements of patterns;
(f) generating the message templates based on the arrangements of patterns; and
(g) parsing free-text message data based on the generated message templates.

34. The apparatus of claim 33, wherein filtering the detected frequent patterns for arrangements in (e) further includes examining each detected frequent pattern, the examination including:
(i) analyzing each item of a detected frequent pattern;
(ii) determining the position of each item in the detected frequent pattern;
(iii) comparing the position of each item in the detected frequent pattern; and
(iv) determining if the items within the detected frequent pattern are consecutive and whether there are gaps of at most n positions between the items.

35. An apparatus comprising:
(a) means for detecting free-text message data located in the free-text data fields;
(b) means for separating the detected free-text message data into textual tokens;
(c) means for searching the free-text message data based on the textual tokens;
(d) means for detecting frequent patterns within the free-text message data;
(e) means for filtering the detected frequent patterns for arrangements of patterns;
(f) means for generating the message templates based on the arrangements of patterns; and
(g) means for parsing free-text message data based on the generated message templates.

36. The apparatus of claim 35, wherein the means for detecting frequent patterns in (d) further comprises means for executing a data mining algorithm.
